(19) United States
(12) Patent Application Publication
(10) Pub. No.: US 2026/0232157 A1
(43) Pub. Date: Aug. 13, 2026

(54) BACKPACK SUPPORTED POWER TOOL WITH ASYMMETRIC CORRUGATED SUPPORT ARM

(71) Applicant: Milwaukee Electric Tool Corporation, Brookfield, WI (US)

(72) Inventors: Kyle J. Reeder, Waukesha, WI (US); Samuel A. Marrella, Menomonee Falls, WI (US); Adam F. Czerwonka, Mukwonago, WI (US); Harry T. Ward, Mequon, WI (US)

(21) Appl. No.: 19/458,343

(22) Filed: Jan. 23, 2026

Related U.S. Application Data
(60) Provisional application No. 63/751,903, filed on Jan. 31, 2025.

(51) Int. Cl. A47L 9/24; A01G 20/47; A47L 5/14; A47L 9/00

(52) U.S. Cl. CPC A47L 9/248; A01G 20/47; A47L 5/14; A47L 9/0009

(57) ABSTRACT

A backpack supported power tool is provided. The power tool includes a frame including a back plate having an upper end and a lower end and defining a back plate plane, and a tool body coupled to the frame by a support arm. The support arm is configured to enable movement of the tool body in a lateral side to side direction relative to the back plate plane and a vertical upward and downward direction relative to the back plate plane. The support arm includes an asymmetric corrugated body. The tool body includes a user interface configured to be gripped by a user to support and direct movement of the tool body. The power tool may be a blower including a primary air mover and a corrugated body, and the corrugated body is arranged between the frame and the blower.

### CROSS-REFERENCE TO RELATED APPLICATIONS

The present application claims priority to U.S. Provisional Patent Application No. 63/751,903, filed on January 31, 2025, the disclosure of which is incorporated by reference herein in its entirety.

### FIELD

The present disclosure relates generally to a backpack supported power tool and an asymmetric corrugated support arm for a backpack supported power tool.

### BACKGROUND

Portable hand-held power tools, e.g., blowers, are popular for, for example, home maintenance and commercial landscaping tasks. Typical hand-held blowers are either powered by gasoline engines or electric motors. A fan is connected to the motor or engine and rotates within a blower housing. The fan generates an air flow that is directed towards an outlet of the housing. An extension tube is generally connected to the outlet of the housing to direct the air flow from the housing therethrough, and the air flow is then exhausted from the tube or through a nozzle connected to the tube.

Electric-powered blowers may be powered by portable batteries. However, there may be trade-offs between the weight of each battery and the efficiency and performance of the blower – for instance, improved efficiency and performance as a result of higher voltage batteries may increase the overall weight of the blower. The increased weight and size of the battery and/or the blower may also reduce the flexibility for operating. Some existing outdoor power tools may utilize a backpack support to mount the power supply of a portable blower. However, the connection between the backpack support and the handheld blower may further limit the flexibility and ease of operation of the blower, including limiting factors such as weight of the handheld portion of the blower, dimensions of the handheld portion of the blower, and flexibility of the connection mechanism between the backpack support and the handheld blower.

In particular, backpack blowers may include a backpack assembly and a blower assembly, where the assemblies are in mechanical contact and have a range of motion relative to each other. A primary air mover can be located on either assembly. Typically, when a primary air mover is part of the backpack assembly, the blower assembly is connected to the backpack assembly through a flexible tube through which air is moved. Where the primary air mover is part of the blower assembly, the blower assembly is connected to the backpack by other means. A technical challenge in developing a means to connect these two assemblies is providing a desired range of motion for a blower operator without requiring too much force from the operator to move the blower assembly through the desired range of motion. Too little force requires the operator to bear the weight of the blower assembly and the blower assembly does not have a consistent neutral position within the desired range of motion. If the force required to move the blower assembly through the desired range of motion is too great, the operator may fatigue more quickly. Further, due to the force of gravity, the force required to pitch the blower assembly up is more than the force required to pitch it down.

Accordingly, improved apparatus for portable, e.g., backpack supported, power tools are desired in the art. In particular, a backpack supported power tool having a tool assembly that may be moved through its range of motion with a relatively constant force from the operator, especially with a pitch motion, would be advantageous.

### BRIEF DESCRIPTION

Aspects and advantages of the present disclosure will be set forth in part in the following description, or may be obvious from the description, or may be learned through practice of the technology.

In accordance with one embodiment, a power tool is provided. The power tool includes a frame including a back plate having an upper end and a lower end and defining a back plate plane; and a tool body coupled to the frame by a support arm. The support arm is configured to enable movement of the tool body in a lateral side to side direction relative to the back plate plane and a vertical upward and downward direction relative to the back plate plane. The support arm includes an asymmetric corrugated body. The tool body includes a user interface configured to be gripped by a user to support and direct movement of the tool body.

In accordance with another embodiment, a backpack supported blower is provided. The backpack supported blower includes a frame configured to be worn on a user’s back, a blower tool, and a corrugated body. The blower tool includes a primary air mover. The corrugated body is arranged between the frame and the blower.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a backpack supported power tool in accordance with embodiments of the present disclosure;

FIG. 2 is a perspective view of a corrugated body in accordance with embodiments of the present disclosure;

FIG. 3 is a cross-sectional view of a first section of a corrugated body in accordance with embodiments of the present disclosure;

FIG. 4 is a cross-sectional view of a second section of a corrugated body in accordance with embodiments of the present disclosure; and

FIG. 5 is a graphical representation of transverse force required to deflect the corrugated body.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

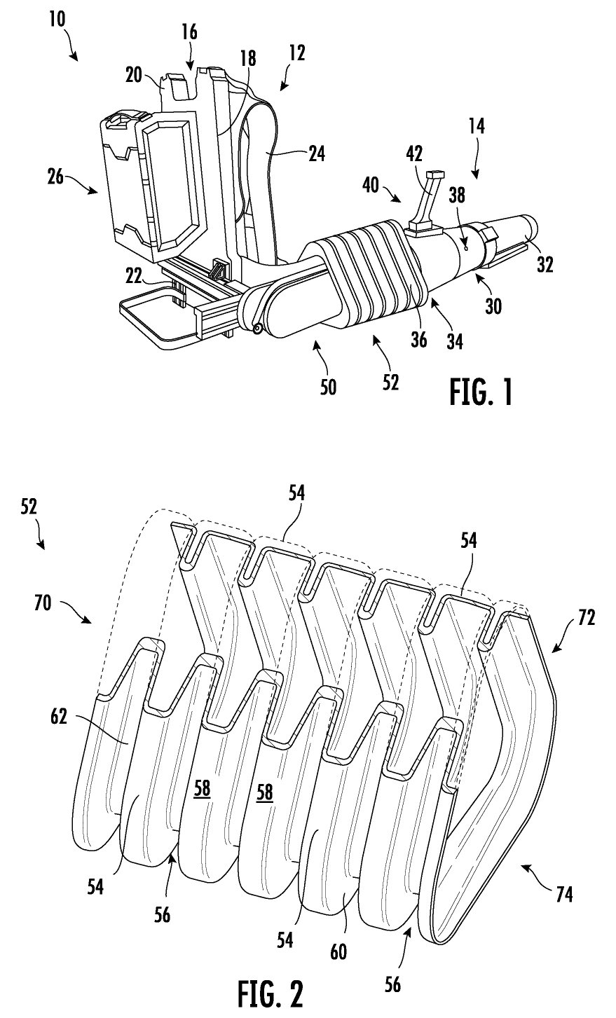

Referring now to the drawings, FIG. 1 illustrates a backpack supported power tool 10 including a backpack assembly 12 and a tool body 14. As shown in FIG. 1, the tool body 14 may be a blower, such as an axial blower. However, the present inventors contemplate that the tool body may be any type of backpack supported power tool, such as a backpack sprayer or a cutting device, e.g., a chain saw or a hedge trimmer.

The backpack assembly 12 includes a frame 16 including a back plate 18. The back plate 18 extends from an upper end 20 to a lower end 22 and defines a back plate plane between the upper end and lower end (best seen in FIG. 8). The backpack assembly 12 further includes shoulder straps 24 coupled to the back plate 18 that are configured to be worn against the user's back to support the weight of the tool 10. The backpack supported power tool 10 may be electrically powered by one or more power tool battery packs (not shown). The backpack assembly 12 may include a battery mounting assembly 26 configured to receive the one or more batteries and provide electrical power to the tool body 14. The batteries may be removably coupled to the backpack assembly 12.

FIG. 1 illustrates the tool body 14 as an axial blower. The axial blower includes a blower housing 30 and a blower outlet tube 32 coupled to a downstream end of the blower housing 30. The blower housing 30 defines a blower inlet bell 34 having a blower inlet 36, and a fan-motor chamber 38 disposed downstream of the blower inlet bell 34. A motor and an axial fan (not shown) are disposed in the fan-motor chamber 38. The motor is electrically powered by the one or more batteries mounted in the backpack assembly 12 and drives the fan to draw air into the blower housing 30 through the inlet 36, and exhaust air from the blower housing 30 through an outlet (not shown) coupled with the blower outlet tube 32. The outlet tube 32 is coupled to the blower housing 30 proximate the outlet in order to direct the exhausted air.

A user interface 40, such as a handle or joystick 42, is coupled to the blower housing 30. When the user interface 40 is in the form of a joystick, the joystick 42 extends in a vertical direction from an upper surface of the blower housing 30. Stated differently, a blower axis may be defined along the airflow direction of the axial blower from the blower inlet 36 through the outlet tube 32, and the joystick 42 may extend in a direction generally perpendicular to the blower axis. The user interface 40 is electrically coupled to the batteries and the motor. The user interface 40 may include one or more buttons (not shown) configured to be actuated by a user to provide electrical current to the motor, which drives the fan and produces a stream of air through the blower housing 30 and outlet tube 32. The handle 42 is also used for positioning and manipulating the outlet tube 32, and thereby directing the outlet and stream of air in a desired direction.

Returning now to FIG. 1, the tool body 14 is side-mounted to the backpack assembly 12. In other words, when the backpack assembly 12 is worn by a user and supported on the user’s back, the tool body 14 extends along one side of the user’s body. While FIG. 1 illustrates the tool body 14 disposed on the right side of the backpack assembly 12, it is to be understood that the tool body 14 may alternatively be disposed on the left side of the backpack assembly 12. Further, the tool 10 may include a plurality of tool bodies 14, e.g., a tool body 14 on each of the right side and the left side, both coupled with the backpack assembly 12.

A support arm 50 may be provided to couple the tool body 14 to the backpack assembly 12. At least a portion of the support arm 50 may include a flexible body. The flexible body may be in the form of a corrugated body 52.

The corrugated body 52, best seen in FIG. 2, may be formed of single-piece construction. The corrugated body 52 may be formed as a generally hollow elongated tubular structure surrounding an open space therein. The corrugated body 52 extends generally along a longitudinal axis, e.g., coaxial with a blower axis of the tool body 14. The corrugated body 52 includes a plurality of ribs 54 along the length of the body 52 and channels 56 between each adjacent rib 54. The ribs 54 and channels 56 each extend about a circumference of the body 52.

As best seen in FIGS. 2-4, each rib 54 includes an exterior surface 58 and a pair of sidewalls 60. The sidewalls 60 extend outward from adjacent channels 56. Each channel 56 includes a channel surface 62. Each rib 54 also includes a first depth D1, measured from a top of one rib 54 to a bottom of an adjacent channel 56. The first depth D1 may generally correspond to a height of the sidewalls 60 orthogonal to the axis. In some aspects, the exterior surfaces 58 and the channel surfaces 62 may be generally parallel along at least a portion of the corrugated body 52.

In general, each rib 54 may move (e.g., flex or bend) about an axis relative to the other ribs 54 by approximately the width of a channel 56. In the present invention, the width of each channel 56 may be asymmetric relative to circumference of the body 52. In other words, the width of each channel 56 may vary about the circumference of the body 52. In this manner, as described further below, the corrugated body 52 may allow for more or less relative movement in different directions.

The corrugated body 52 includes a first section 70 and a second section 72. The first section 70 and the second section 72 may each extend at least a portion of a circumference of the corrugated body 52. In some aspects of the invention, additional sections may form portions of the circumference of the corrugated body 52, e.g., a third section, fourth section, fifth section, etc.

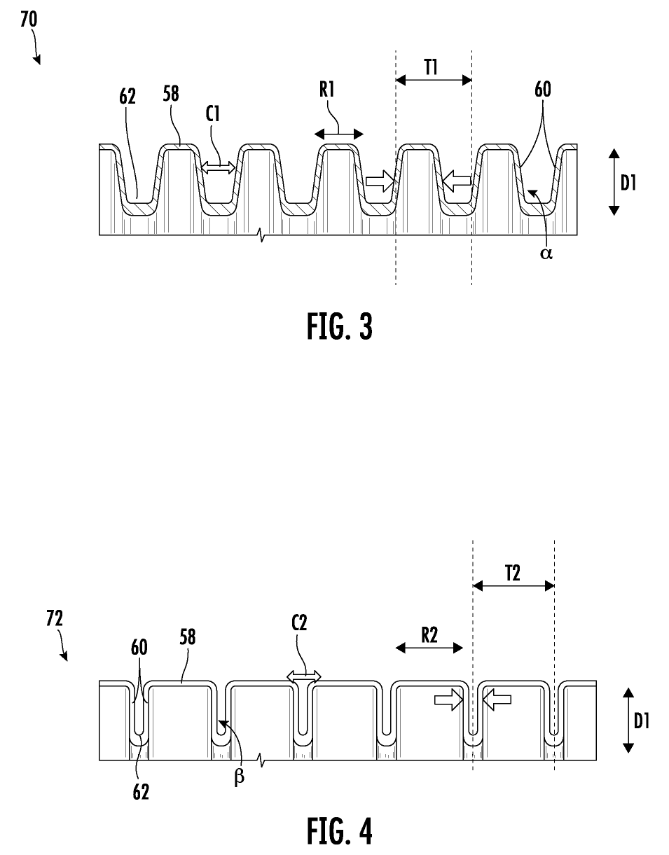

FIG. 3 illustrates a partial cross-sectional view of the first section 70. The first section 70 includes ribs 54 having a rib length R1 and channels 56 adjacent the ribs having a channel length C1. The sidewalls 60 may extend at an angle α from the channel surface 62. The angle α may be an acute angle, e.g., between about 50 degrees and about 80 degrees. In this manner, the space between adjacent ribs 54 may be narrower on top, i.e., near the exterior surface 58, than at the bottom, i.e., near the channel surface 62. Along the axial direction, a length of one rib 54 and one adjacent channel 56 of the first section 70 may be referred to as the thickness T1 of the ribs of the first section. In some aspects, the rib length R1, the channel length C1, and the thickness T1 are the same for every rib 54 in the first section 70.

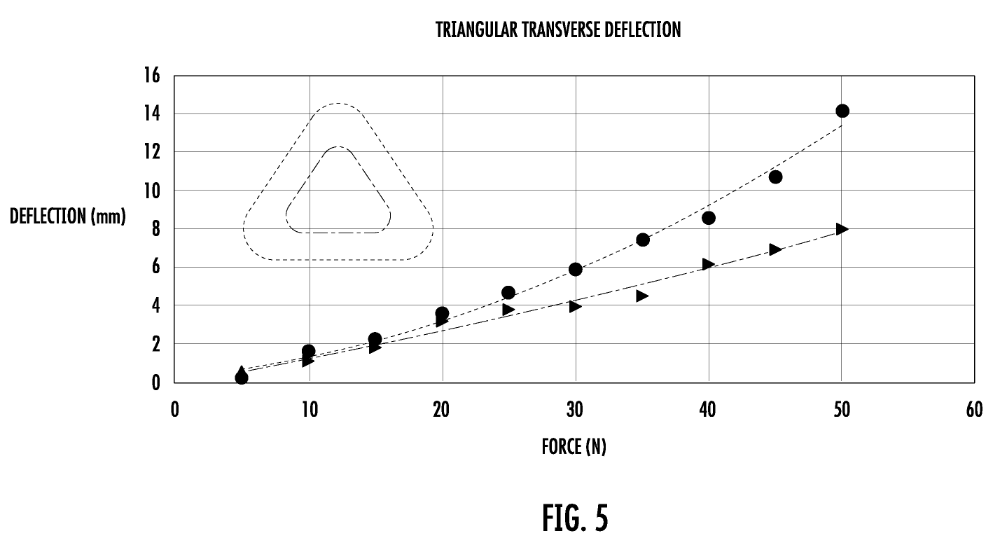

FIG. 4 illustrates a partial cross-sectional view of the second section 72. The second section 72 includes ribs 54 having a rib length R2 and channels 56 adjacent the ribs having a channel length C2. The sidewalls 60 may extend at an angle β from the channel surface 62. The angle β may be in a range of from about 80 degrees to about 100 degrees, such as about 90 degrees, such that the sidewalls 60 extend substantially vertically from the channel surface 62. In this manner, the space between adjacent ribs 54 may be approximately equal at the top, i.e., near the exterior surface 58, and at the bottom, i.e., near the channel surface 62. Along the axial direction, a length of one rib 54 and one adjacent channel 56 of the second section 72 may be referred to as the thickness T2 of the ribs of the first section. In some aspects, the rib length R2, the channel length C2, and the thickness T2 are the same for every rib 54 in the second section 72.

As shown in FIGS. 3 and 4, the thickness T1 of the first section 70 and the thickness T2 of the second section 72 may be the same, i.e., approximately equal. However, the first section may include a smaller rib length R1 than the rib length R2 of the second section. Conversely, the first section may include a larger channel length C1 than the channel length C2 of the second section.

For instance, a ratio of the rib length R1 to the channel length C1 in the first section 70 can be in a range from about 1:0.75 to about 1:1.25. In contrast, a ratio of rib length R2 to channel length C2 in the second rib section can be in a range from about 1:0.05 to about 1:0.25.

Further, FIG. 2 illustrates a third section 74 forming a transition between the first section 70 and the second section 72. The third section 74 includes ribs with a thickness T3 approximately equal to both T1 and T2, but with a rib length and a channel length that varies about the circumference of the third section 74.

Turning back to FIG. 2, in some aspects of the present invention, the corrugated body 52 may have a generally triangular cross-sectional shape. As shown in FIG. 2, the generally triangular shape may include radiused corners. However, alternative cross-sectional shapes are also contemplated within the scope of the invention, such as oblong shapes, e.g., elliptical, four-sided shapes, five-sided shapes, six-sided shapes, or other polygonal shapes. The present inventors have found that forming the corrugated body 52 with a generally elongated bottom or lower portion of the cross-sectional shape, e.g., having a generally horizontal bottom side of the triangle formed at the bottom of the corrugated body 52, results in improved stiffness of the corrugated body 52 when bent in a downward direction relative to the axis. As the corrugated body 52 supports the power tool 10 at a distal end thereof, increased stiffness is required to support the weight of the power tool 10.

In particular, FIG. 5 illustrates a graph of the transverse deflection of a corrugated body 52 having a triangular shape. As shown in FIG. 5, a greater transverse force is required to bend the corrugated body 52 in the downward direction relative to the axis as compared to the transverse force required to bend the corrugated body 52 in the upward direction. In other words, the corrugated body 52 requires less force to bend in the upward direction than the downward direction. In this manner, the corrugated body 52 provides improved support to suspend the power tool 10 from the distal end of the body 52. This may keep the power tool 10 from dropping too low or contacting the ground when a user is not holding the user interface 40 while enabling a user to more easily direct the power tool 10 in an upward direction.

As shown in FIGS. 1 and 2, the first section 70 of the corrugated body 52 described above may generally form one side of the triangle, the second section 72 of the corrugated body 52 may generally form a second side of the triangle, and the third section or transition section may form the bottom section of the triangle having the greatest stiffness. In particular, when arranged as the support arm 50 of the power tool 10, the first section 70 may form an outer side, i.e., facing away from a user, and the second section 72 may form an inner side, i.e., facing toward a user of the power tool 10.

The corrugated body 52 may move in a given direction (e.g., a first direction, a second direction, a third direction, or a fourth direction) based on the thickness of the ribs 54, the width of the channel 56, and the cross-sectional shape of the corrugated body 52. The first and second directions are opposite one another (e.g., up and down) and the third and fourth directions are opposite one another (e.g., left and right). The first, second, third, and fourth directions may also be orthogonal with respect to the axis of the body 52. As described above, the generally horizontal bottom side of the triangular cross-sectional shape forming the third section 74 allows for increased stiffness, i.e., resistance to movement, in the second (downward) direction. The larger rib length R2 and smaller channel length C2 along the second section 72 allows for the second section 72 flex and deflect more like a flexible beam, e.g., similarly to the movement of a spring, to enable the corrugated body 52 to wrap in a direction around the user. The smaller rib length R1 and increased channel length C1 along the first section 70 allows for more movement in the fourth direction (or otherwise in a lateral direction away from the user’s body) as compared to movement in the third direction. The corrugated body 52 may also move or flex in an infinite number of directions between the adjacent first, second, third, and fourth directions (e.g., may move in a direction between the first and third directions).

When using the backpack blower 10, the user may move the joystick 46 in order to move the power tool, e.g., axial blower, and change the direction of the exhausted air (e.g., to change where debris is blown). The cross-sectional shape of the body 52 allows a user to make larger adjustments to a blowout direction (i.e., direction of the exhausted air) in a horizontal direction than in a vertical direction. A rib 54 can continue to move relative to the other ribs 54 until it contacts an adjacent rib 54.

When a user releases the joystick 42 (i.e., and no longer supports the tool body 14), gravity moves the tool body 14 toward the ground. The stiffness in the downward direction of the corrugated body 52 allows for minimal movement in the vertical direction. This keeps the tool body 14 from contacting the ground when the user is no longer holding the joystick 42 and opposing the force of gravity.

Returning to FIG. 1, the corrugated body 52 forms a part of the support arm 50 for the tool body 52. In the case of an axial blower as shown in FIG. 1, the entire tool body, including the air flow path and the fan/motor assembly, are arranged downstream of the support arm and the corrugated body 52. In other words, the corrugated body 52, while hollow, does not form any part of the air flow path of the axial blower. In this manner, the corrugated body 52 is formed with improved support characteristics for the tool body, e.g., supporting the blower’s weight, increasing the range of motion, improving flexibility and optimizing the force needed to flex the support arm, without consideration of potential air flow characteristics through the corrugated body 52.

Further aspects of the disclosure are provided by one or more of the following embodiments:

A power tool comprising: a frame including a back plate having an upper end and a lower end and defining a back plate plane; and a tool body coupled to the frame by a support arm, the support arm configured to enable movement of the tool body in a lateral side to side direction relative to the back plate plane and a vertical upward and downward direction relative to the back plate plane, wherein the support arm comprising an asymmetric corrugated body; the tool body comprising a user interface configured to be gripped by a user to support and direct movement of the tool body.

The power tool of any one or more of the embodiments, wherein the asymmetric corrugated body comprises a generally triangular cross-sectional shape along a longitudinal axis of the asymmetric corrugated body extending from the frame to the tool body.

The power tool of any one or more of the embodiments, wherein the asymmetric corrugated body comprises a first rib section and a second rib section.

The power tool of any one or more of the embodiments, wherein a channel length between ribs of the first rib section and spacing between ribs of the second rib section is unequal.

The power tool of any one or more of the embodiments, wherein the channel length between ribs of the first rib section is greater than the channel length between ribs of the second rib section.

The power tool of any one or more of the embodiments, wherein the second rib section is disposed closer to the back plate than the first rib section such that the second rib section is configured to be arranged on a user-facing side of the support arm.

The power tool of any one or more of the embodiments, wherein the first rib section is configured to be arranged on an outward-facing side of the support arm.

The power tool of any one or more of the embodiments, wherein a ratio of rib axial length to channel axial length in the first rib section is in a range from about 1:0.75 to about 1:1.25.

The power tool of any one or more of the embodiments, wherein a ratio of rib axial length to channel axial length in the second rib section is in a range from about 1:0.05 to about 1:0.25.

The power tool of any one or more of the embodiments, wherein the asymmetric corrugated body has a greater stiffness in a downward direction than in an upward direction relative to a central longitudinal axis of the asymmetric corrugated body.

The power tool of any one or more of the embodiments, wherein a force required to deflect the asymmetric corrugated body in the downward direction is greater than a force required to deflect the asymmetric corrugated body in the upward direction.

The power tool of any one or more of the embodiments, wherein the tool body comprises a blower, the blower comprising a blower housing defining a blower inlet bell and a fan-motor chamber, a fan and a motor disposed in the fan-motor chamber, and an outlet tube coupled to a downstream end of the blower housing, wherein the support arm is coupled to the blower inlet bell.

A backpack supported blower comprising: a frame configured to be worn on a user’s back; a blower tool, the blower comprising a primary air mover; and a corrugated body; wherein the corrugated body is arranged between the frame and the blower.

The backpack supported blower of any one or more of the embodiments, wherein the corrugated body is located upstream of the primary air mover relative to a direction of air flow generated by the primary air mover.

The backpack supported blower of any one or more of the embodiments, wherein the corrugated body forms a support arm mechanically coupled between the frame and the blower tool.

The backpack supported blower of any one or more of the embodiments, wherein the primary air mover generates a flow of air along an air flow path, wherein the corrugated body is not part of the air flow path.

The backpack supported blower of any one or more of the embodiments, the corrugated body comprising a plurality of ribs, wherein the plurality of ribs are asymmetric about a circumference of the corrugated body.

The backpack supported blower of any one or more of the embodiments, wherein the corrugated body comprises a first rib section and a second rib section, further wherein spacing between ribs of the first rib section and spacing between ribs of the second rib section are unequal.

The backpack supported blower of any one or more of the embodiments, wherein the spacing between ribs of the first rib section is greater than the spacing between ribs of the second rib section.

The backpack supported blower of any one or more of the embodiments, wherein the corrugated body has a greater stiffness in a downward direction than in an upward direction relative to a central longitudinal axis of the corrugated body.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A power tool comprising: a frame including a back plate having an upper end and a lower end and defining a back plate plane; and a tool body coupled to the frame by a support arm, the support arm configured to enable movement of the tool body in a lateral side to side direction relative to the back plate plane and a vertical upward and downward direction relative to the back plate plane, wherein the support arm comprising an asymmetric corrugated body; the tool body comprising a user interface configured to be gripped by a user to support and direct movement of the tool body.

2. The power tool of claim 1, wherein the asymmetric corrugated body comprises a generally triangular cross-sectional shape along a longitudinal axis of the asymmetric corrugated body extending from the frame to the tool body.

3. The power tool of claim 1, wherein the asymmetric corrugated body comprises a first rib section and a second rib section.

4. The power tool of claim 3, wherein a channel length between ribs of the first rib section and spacing between ribs of the second rib section is unequal.

5. The power tool of claim 4, wherein the channel length between ribs of the first rib section is greater than the channel length between ribs of the second rib section.

6. The power tool of claim 3, wherein the second rib section is disposed closer to the back plate than the first rib section such that the second rib section is configured to be arranged on a user-facing side of the support arm.

7. The power tool of claim 6, wherein the first rib section is configured to be arranged on an outward-facing side of the support arm.

8. The power tool of claim 3, wherein a ratio of rib axial length to channel axial length in the first rib section is in a range from about 1:0.75 to about 1:1.25.

9. The power tool of claim 3, wherein a ratio of rib axial length to channel axial length in the second rib section is in a range from about 1:0.05 to about 1:0.25.

10. The power tool of claim 1, wherein the asymmetric corrugated body has a greater stiffness in a downward direction than in an upward direction relative to a central longitudinal axis of the asymmetric corrugated body.

11. The power tool of claim 10, wherein a force required to deflect the asymmetric corrugated body in the downward direction is greater than a force required to deflect the asymmetric corrugated body in the upward direction.

12. The power tool of claim 1, wherein the tool body comprises a blower, the blower comprising a blower housing defining a blower inlet bell and a fan-motor chamber, a fan and a motor disposed in the fan-motor chamber, and an outlet tube coupled to a downstream end of the blower housing, wherein the support arm is coupled to the blower inlet bell.

13. A backpack supported blower comprising: a frame configured to be worn on a user’s back; a blower tool, the blower comprising a primary air mover; and a corrugated body; wherein the corrugated body is arranged between the frame and the blower.

14. The backpack supported blower of claim 13, wherein the corrugated body is located upstream of the primary air mover relative to a direction of air flow generated by the primary air mover.

15. The backpack supported blower of claim 13, wherein the corrugated body forms a support arm mechanically coupled between the frame and the blower tool.

16. The backpack supported blower of claim 13, wherein the primary air mover generates a flow of air along an air flow path, wherein the corrugated body is not part of the air flow path.

17. The backpack supported blower of claim 13, the corrugated body comprising a plurality of ribs, wherein the plurality of ribs are asymmetric about a circumference of the corrugated body.

18. The backpack supported blower of claim 17, wherein the corrugated body comprises a first rib section and a second rib section, further wherein spacing between ribs of the first rib section and spacing between ribs of the second rib section are unequal.

19. The backpack supported blower of claim 18, wherein the spacing between ribs of the first rib section is greater than the spacing between ribs of the second rib section.

20. The backpack supported blower of claim 13, wherein the corrugated body has a greater stiffness in a downward direction than in an upward direction relative to a central longitudinal axis of the corrugated body.
